(19) United States
(12) Patent Application Publication
(10) Pub. No.: US 2003/0013452 A1
(43) Pub. Date: Jan. 16, 2003

(54) Hierarchical cellular radio communication system

(75) Inventors: Bernard Hunt, Redhill (GB); Matthew P.J. Baker, Canterbury (GB); Timothy J. Moulsley, Caterham (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/191,020

(22) Filed: Jul. 8, 2002

(30) Foreign Application Priority Data
Jul. 13, 2001 (GB) 0117071.1

(51) Int. Cl. H04Q 7/20

(52) U.S. Cl. 455/449; 455/450

(57) ABSTRACT

A hierarchical cellular radio communication system comprises a plurality of pico cells (106) and an umbrella macro cell (102), each cell having a controlling primary station (104, 108). A secondary station (110) has a communication channel with the system split into a control sub-channel (212), for the transmission of control information, and a data sub-channel (214), for the transmission of user data. The control sub-channel connects the secondary station to the primary station serving the macro cell while the data sub-channel connects the secondary station to the primary station serving the pico cell.

The control portions of the channel are largely served by the umbrella macro cell to reduce the overheads of frequent mobility management, while the data portions are largely served by the pico cells which can support high data rates and large data density. For a system serving packet data, the pico cell layer can be non-contiguous.

The present invention relates to a radio communication system and further relates to primary and secondary stations for use in such a system and to a method of operating such a system. While the present specification describes a system with particular reference to the Universal Mobile Telecommunication System (UMTS), it is to be understood that such techniques are equally applicable to use in other mobile radio systems.

Cellular radio communication systems, such as UMTS and GSM (Global System for Mobile communications), are well known. In such systems the cells generally have a range of sizes, for example small in urban areas and large in rural areas. Typically the capacity of a cell is independent of its size, so that a small cell offers a higher data density. Hence, by decreasing cell size, and therefore the number of users per cell, it should be able to provide a higher data rate to individual users. However, a disadvantage of small cells is the need for transferring a communication link between cells as a user moves around. This carries overheads in terms of both over-the-air signalling and network signalling. In addition, deploying a contiguous network of small cells can be costly because of the amount of system hardware required.

In order to maintain successfully a continuous connection with a user, it is common to employ a technique called soft handover as a user nears the edge of a cell. Using this technique, connections are set up between the user and neighbouring cells, in addition to the current cell. All the links carry the same data, and as the user moves away from the original cell that link becomes terminated. This technique allows connections to be maintained, and may increase system capacity over the air, since the diversity effect may reduce the total power required to maintain the link quality. However, it also increases the network load, since all control and data information needs to be passed between all the cells linked to the user.

One approach to network deployment is to use a hierarchical cell structure with a combination of macro cells and pico cells, where the pico cells serve an area also covered by the macro cell. Such a structure is able to take account of different users requiring different data traffic types. Typically, the “umbrella” macro cell is used to serve those users requiring low bit rate, high mobility services (such as voice telephony), since it has adequate bit rate, and the handover requirement is lower than with small cells.

The network of pico cells is used to serve those users requiring higher bit rate services, with lower mobility. The small cells enable high data rate links to be set up, which could not be carried by the macro cell, while low mobility keeps the handover requirements manageable. A typical example of a user considered to have a low mobility within the pico cell network would be where the duration of the handover process is much less than the typical time for which the user is in one pico cell. The pico cellular network may be contiguous, or cover “hot spots” only.

However, there are some problems with this scenario, particularly when considering future cellular networks where there will be increased demand for high bit rates at higher mobility. Firstly, the overhead of network signalling to support handover may limit the capacity of the system, so expensive spectrum resources are wasted. Secondly, as the speed at which terminals move increases, and the size of cells decreases (to increase capacity/data rates) there will come a point at which the terminal is moving too quickly to be successfully handed over from one cell to the next before it has already left the next cell. Thirdly, as the size of cells decreases, the cost of deploying a fully contiguous pico cellular network may increase prohibitively.

An example of a system having a hierarchical cell structure is disclosed in International Patent Application WO 00/05912. This system has three types of cells (macro, micro and pico), with pico cells supporting the highest data rates. The system generally allocates a mobile terminal to the cell type providing the strongest signal, although the communication requirements of the mobile may also be considered.

Another example of such a system is disclosed in U.S. Pat. No. 5,546,443. This system comprises macro and micro cells and improves spectrum efficiency by all the micro cells in the area of an umbrella macro cell sharing an information channel with the macro cell. The information channel enables transmission of call requests and paging messages, together with information relating to location and characteristics of mobile and base stations.

An object of the present invention is to address the problems of known hierarchical cellular radio systems.

According to a first aspect of the present invention there is provided a hierarchical cellular radio communication system comprising a secondary station, a plurality of pico cells and an umbrella macro cell, each cell having a respective controlling primary station, and a communication channel between the secondary station and a primary station, the communication channel comprising control and data sub-channels for the respective transmission of control information and user data, wherein means are provided for connecting a control sub-channel between the secondary station and the controlling primary station for the macro cell and for connecting a data sub-channel between the secondary station and the controlling primary station for a pico cell.

Use of different cell types to service control and data sub-channels enables more efficient operation. The control portions of the channel are largely served by the umbrella macro cell, to reduce the overheads of frequent mobility management, while the data portions are largely served by the pico cells, which can support high data rates and large data density. For a system serving packet data, this arrangement allows the pico cell layer to be non-contiguous.

The communication link between a pico cell and the secondary station may be unidirectional, typically operable only in a downlink direction.

According to a second aspect of the present invention there is provided a primary station for use in a hierarchical cellular radio communication system comprising a secondary station, a plurality of pico cells and an umbrella macro cell, each cell having a respective controlling primary station, and a communication channel between the secondary station and a primary station, the communication channel comprising control and data sub-channels for the respective transmission of control information and user data, wherein means are provided for connecting one of a control sub-channel and a data sub-channel between the secondary station and the primary station, the other sub-channel being connected to a primary station controlling a cell at a different hierarchical level.

According to a third aspect of the present invention there is provided a secondary station for use in a hierarchical cellular radio communication system comprising a plurality of pico cells and an umbrella macro cell, each cell having a respective controlling primary station, and a communication channel between the secondary station and a primary station, the communication channel comprising control and data sub-channels for the respective transmission of control information and user data between the secondary station and a primary station, wherein means are provided for connecting a control sub-channel between the secondary station and the controlling primary station for the macro cell and for connecting a data sub-channel between the secondary station and the controlling primary station for a pico cell.

According to a fourth aspect of the present invention there is provided a method of operating a hierarchical cellular radio communication system comprising a secondary station, a plurality of pico cells and an umbrella macro cell, each cell having a respective controlling primary station, and a communication channel between the secondary station and a primary station, the communication channel comprising control and data sub-channels for the respective transmission of control information and user data between the secondary station and a primary station, the method comprising connecting a control sub-channel between the secondary station and the controlling primary station for the macro cell and connecting a data part between the secondary station and the controlling primary station for a pico cell.

The present invention is based upon the recognition, not present in the prior art, that using different cell types to handle the control and user data portions of a communication channel may enable improved performance.

Embodiments of the present invention will now be described, by way of example, with reference to the accompanying drawings, wherein:

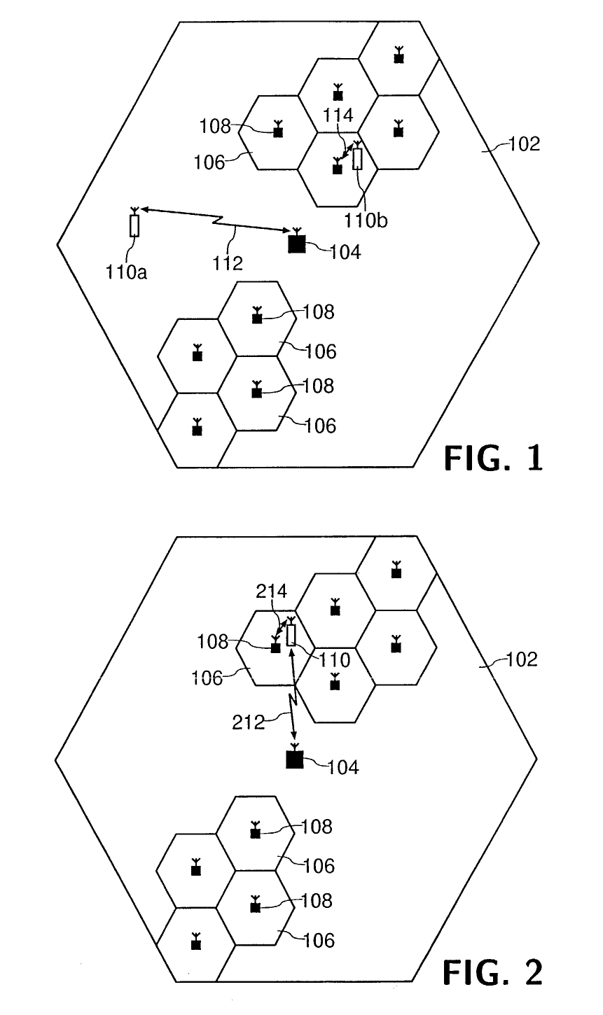

FIG. 1 shows a known hierarchical cellular communication system; and

FIG. 2 shows a hierarchical cellular communication system made in accordance with the present invention.

In the drawings the same reference numerals have been used to indicate corresponding features.

A known hierarchical cellular communication system is illustrated in FIG. 1, comprising an umbrella macro cell 102 and a plurality of pico cells 106. The macro cell 102 has a controlling primary station 104, and each of the pico cells 106 has a respective controlling primary station 108. The pico cells 106 do not provide complete coverage of the area covered by the macro cell 102. A secondary station 110a, which is not in the coverage area of a pico cell 106, communicates with the macro cell's Base Station (BS) 104 via a dedicated channel 112. Another secondary station 110b, which is in the coverage area of a pico cell 106, communicates with the respective pico cell's BS 108 via a dedicated channel 114.

Typically, a bidirectional communications link, such as the dedicated channels 112,114, carries two types of traffic: control data and user (application) data. Generally the control information does not require a high data rate, but needs to be connected continuously (or at least at regular, short, intervals). In future communications systems, it is envisaged that the user data will require high data rates, but it will be sent in a packet format (short blocks of data, rather than continuous transmission).

A hierarchical cellular communication system made in accordance with the present invention is shown in FIG. 2, providing more effective management of a radio link between the system and a Mobile Station (MS) 110. This is done by arranging the radio access network within a hierarchical cell structure and allowing a communications link to be split between two types of cells, such that control data is passed over a control sub-channel 212 between a terminal 110 and a BS 104 controlling a macro cell 102, and user data is passed over a data sub-channel 214 between a terminal 110 and a BS 108 controlling a pico cell 106.

The macro cell 102 offers best support for the control data, as it has sufficient capacity to support the traffic, and covers a wide area so a continuous link can be maintained as the user moves around without the need for an excessive number of handovers between cells. At the same time, the high capacity pico cell 106 supplies the user data at a high rate. Because the control sub-channel 212 is set up with the macro cell's BS 104, this is able to manage the selection of the most appropriate pico cell 106 for use in user data transfer at any one time. Since the user data is sent in packets, it is not necessary for the pico cellular coverage to be contiguous, although there may be delays in packet transmission if it is not contiguous.

Soft handover between pico cells 106 is not required, since the data is packetised and can be sent when the user only requires transmission from one cell 106, although it could be supported if it provided a significant diversity gain. It should be noted that this presumes that a user is not moving so quickly that it is impossible to send a complete packet from one pico cell 106. If a user is moving too fast, the system may choose to reduce the size of the data packets so that there is time for a complete packet to be sent while the user is in the coverage area of a single pico cell 106.

It may be that there is some further control information which is required to be sent within the pico cell 106 (e.g. in support of fast physical layer procedures, such as power control). Such information would be associated with individual packets on an “on-off” basis, i.e. only transmitted when data packets are being transmitted.

A more detailed embodiment is now considered, based on the WCDMA (Wideband Code Division Multiple Access) Frequency Division Duplex (FDD) mode of UMTS. In this embodiment the macro cell 102 is deployed using frequencies Fmu and Fmd, for its uplink and downlink respectively. The pico cells 106 use frequencies Fpu and Fpd, with the different cells 106 differentiated by the use of respective scrambling codes.

For a user operating under this embodiment, the higher layer and protocol connection to the core network terminates in the macro cell BS 104 (and/or in some control entity connected to the macro cell BS). This is also the point to which data for the user is delivered by the core network, and where it collects data from the user. The macro cell BS 104 has direct links to the pico cell base stations 108 included within the umbrella macro cell 102, and routes data to and from whichever is appropriate for current communications in a manner which is transparent to the network.

By scanning the broadcast channels of the pico cellular network, the user's MS 110 is able to determine which pico cell 106 it is within, or from which pico cell BS 108 it is receiving signals having the best Signal to Interference Ratio (SIR). The MS 110 can signal the identity of this cell 106 to the macro cell's BS 104, either on a regular basis, whenever it changes, or on demand from the macro cell 102. When there is a data packet to be transmitted to the user, the macro cell 102 routes the data to the identified pico cell 106, and sends notification to the MS 110, via the control sub-channel 212 between the macro cell 102 and the MS 110, that it should receive a data packet using the particular data sub-channel 214 allocated for use by the pico cell 106. Should the user be out of range of any pico cell 106, the BS 104 can queue the data until such time as the user enters a pico cell 106.

In a variation on the above embodiment, when the MS 110 is receiving good BCH (Broadcast CHannel) signals from a plurality of pico cells 106 it signals a list of suitable pico cells to the macro cell BS 104. The network chooses a pico cell 106 for the transmission of the next data packet depending on considerations such as relative traffic loadings between the pico cells. The macro cell BS 104 signals the identity of the chosen pico cell 106 to the MS 110 to prepare it to receive the packet. As well as the list of pico cells 106, the MS 110 could signal quality measurements relating to each pico cell to the macro cell BS 104, enabling the BS 104 to determine a suitable pico cell 106. The macro cell BS 104 may also instruct the chosen pico cell BS 108 to vary transmission parameters (such as data rate, transmission power) to modify the quality of the chosen link.

In another variation on the above embodiments, a pico cell BS 108 could scan for any MS 110 from which it could receive transmissions and signal the identity or identities to the macro cell BS 104. Such an embodiment has the advantage of reducing the power consumption of the MS 110. Alternatively, in a system in which the location of the MS 110 could be determined, the closest pico cell BS 108 could be selected for transmissions.

A range of other embodiments of this scheme are possible. The pico cells 106 may only support one way (typically downlink) sub-channels 214, optionally using broadcast technologies. Different types of cells 102,106 may use different communications modes, e.g. UMTS FDD and UMTS Time Division Duplex (TDD), or possibly even different communications systems (for example a UMTS macro cell 102 and a HIPERLAN pico cell 106).

Information regarding the pico cellular location of the MS 110 could be used by the macro cell's BS 104 to enable antenna beam forming for its transmission and reception from that MS 110, thereby increasing the capacity and link quality within the macro cell 102 (and also aiding handover on the macro cell layer).

An operator could set up a low cost/capacity macro cellular network in a foreign country, to allow roaming users to connect directly to their home network for control, but the user data will be routed via a local operator under a traditional roaming agreement. Such an arrangement could be advantageous with future virtual home environment type systems, in which a user's operating environment is the same wherever they access the system. In such systems information relating to the environment must reside in the network, to allow access from different terminals. It may be required to restrict transmission of associated information to the home network, or alternatively there may be speed contraints to accessing such information via another network.

Although the present invention has been described above in terms of macro and pico cells, it is equally applicable to a wide range of cell sizes in a hierarchical cellular system, and is not limited to a system having only two levels of cells. For example, an umbrella cell created by a satellite or High Altitude Platform (HAP) could be used in conjunction with an underlay of terrestrial macro cells and pico cells to serve high-speed users such as planes, trains etc. If the number of users in such a system was small, it might be possible to use a broadcast system with a low capacity return channel (e.g. for interactive TV) as the control channel in the satellite/HAP cell.

From reading the present disclosure, other modifications will be apparent to persons skilled in the art. Such modifications may involve other features which are already known in the design, manufacture and use of radio communication systems and component parts thereof, and which may be used instead of or in addition to features already described herein.

In the present specification and claims the word “a” or “an” preceding an element does not exclude the presence of a plurality of such elements. Further, the word “comprising” does not exclude the presence of other elements or steps than those listed.

1. A hierarchical cellular radio communication system comprising a secondary station, a plurality of pico cells and an umbrella macro cell, each cell having a respective controlling primary station, and a communication channel between the secondary station and a primary station, the communication channel comprising control and data sub-channels for the respective transmission of control information and user data, wherein means are provided for connecting a control sub-channel between the secondary station and the controlling primary station for the macro cell and for connecting a data sub-channel between the secondary station and the controlling primary station for a pico cell.

2. A system as claimed in claim 1, characterised in that the data sub-channel is unidirectional.

3. A system as claimed in claim 2, characterised in that the data sub-channel is operable in a downlink direction only.

4. A system as claimed in claim 1, characterised in that means are provided for determining that the speed of the secondary station prevents reception of a complete data packet from one pico cell and for reducing the size of transmitted data packets in response.

5. A system as claimed in claim 1, characterised in that the control and data sub-channels are operated according to different communication modes.

6. A primary station for use in a hierarchical cellular radio communication system comprising a secondary station, a plurality of pico cells and an umbrella macro cell, each cell having a respective controlling primary station, and a communication channel between the secondary station and a primary station, the communication channel comprising control and data subchannels for the respective transmission of control information and user data, wherein means are provided for connecting one of a control sub-channel and a data sub-channel between the secondary station and the primary station, the other sub-channel being connected to a primary station controlling a cell at a different hierarchical level.

7. A primary station as claimed in claim 6, characterised in that the primary station is adapted for use as the controlling primary station for a macro cell and in that means are provided for exchanging user data relating to the secondary station with the controlling primary station for the pico cell to which the data sub-channel is connected.

8. A primary station as claimed in claim 6, characterised in that the primary station is adapted for use as the controlling primary station for a pico cell and in that means are provided for exchanging user data transmitted via the data sub-channel with the controlling primary station for the macro cell.

9. A secondary station for use in a hierarchical cellular radio communication system comprising a plurality of pico cells and an umbrella macro cell, each cell having a respective controlling primary station, and a communication channel between the secondary station and a primary station, the communication channel comprising control and data sub-channels for the respective transmission of control information and user data between the secondary station and a primary station, wherein means are provided for connecting a control sub-channel between the secondary station and the controlling primary station for the macro cell and for connecting a data sub-channel between the secondary station and the controlling primary station for a pico cell.

10. A secondary station as claimed in claim 9, characterised in that means are provided for determining which pico cell provides the best signal and for signalling this determination to the controlling primary station for the macro cell.

11. A secondary station as claimed in claim 9, characterised in that means are provided for determining which pico cells provide signals of acceptable quality and for signalling this determination to the controlling primary station for the macro cell.

12. A method of operating a hierarchical cellular radio communication system comprising a secondary station, a plurality of pico cells and an umbrella macro cell, each cell having a respective controlling primary station, and a communication channel between the secondary station and a primary station, the communication channel comprising control and data sub-channels for the respective transmission of control information and user data between the secondary station and a primary station, the method comprising connecting a control sub-channel between the secondary station and the controlling primary station for the macro cell and connecting a data part between the secondary station and the controlling primary station for a pico cell.
